(19) United States
(12) Patent Application Publication
(10) Pub. No.: US 2024/0289789 A1
(43) Pub. Date: Aug. 29, 2024

(54) SECURE COMPUTING SYSTEM, FINANCIAL INSTITUTION SERVER, INFORMATION PROCESSING SYSTEM, SECURE COMPUTING METHOD, AND RECORDING MEDIUM

(71) Applicant: NEC Corporation, Minato- ku, Tokyo (JP)

(72) Inventors: Daisuke MATSUDA, Tokyo (JP); Yoshiyuki ETOU, Tokyo (JP); Satoru FUJII, Tokyo (JP); Ryo FURUKAWA, Tokyo (JP); Isamu TERANISHI, Tokyo (JP); Wataru ITONAGA, Tokyo (JP)

(73) Assignee: NEC Corporation, Minato- ku, Tokyo (JP)

(21) Appl. No.: 18/570,676

(22) PCT Filed: Jun. 21, 2021
(86) PCT No.: PCT/JP2021/023445

§ 371 Date: Dec. 15, 2023

(51) Int. Cl. G06Q 20/40

(52) U.S. Cl. CPC G06Q 20/40

(57) ABSTRACT

A secure computing system according to the present disclosure is used to analyze financial transactions based on information regarding customer assets, and comprises: a parameter reception means that receives input of encrypted parameters of a plurality of models generated by each of a plurality of financial institutions; a secure computing means that integrates the plurality of encrypted parameters through secure computation; and an output means that outputs, in an encrypted format, the parameters integrated by the secure computing means.

### TECHNICAL FIELD

The present disclosure relates to a secure computing system, a financial institution server, an information processing system, a secure computing method, and a recording medium.

### BACKGROUND ART

Financial institutions extract customers to whom the financial institutions propose financial products such as an investment trust by using information regarding asset holdings, revenue, and states of asset management of customers (individuals and corporations) held by the financial institutions themselves. As means to extract the customers, a model using artificial intelligence (AI) is used. In a case where the model using the AI is generated, customer information held by each financial institution is used. In order to improve performance and accuracy of the model, a technology of performing prediction processing on distributed customer data while protecting privacy is used.

For example, PTL 1 discloses a system that performs prediction processing in an encrypted state with an encrypted prediction model and user information encrypted by the same method as a shared prediction model.

### CITATION LIST

### Patent Literature

PTL 1: JP 2019-215512 A

### SUMMARY OF INVENTION

### Technical Problem

However, in the invention described in PTL 1 described above, since data predicted by the single prediction model is output, there is a limitation to improve accuracy of the predicted data. When customer information is analyzed in a financial industry, a more accurate model can be generated by using information of models owned by a plurality of financial institutions than by using models owned by individual financial institutions. However, the model owned by each financial institution cannot be provided to a third party because it is information that needs to be kept confidential.

An example of an object of the present disclosure is to provide a more accurate model while concealing parameters of each model.

### Solution to Problem

A secure computing system in one aspect of the present disclosure includes parameter acceptance means that accepts, for a plurality of models generated in a plurality of financial institutions and used to analyze a financial transaction based on information regarding assets of a customer, inputs of concealed parameters of the plurality of models, secure computing means that integrates the plurality of concealed parameters by secure computing, and output means that outputs, in a concealed format, the parameters integrated by the secure computing means.

A financial institution server in one aspect of the present disclosure includes analysis means regarding a financial transaction of a customer by using an update model updated by federated learning using secure computing based on customer information or financial transaction information regarding assets of the customer.

An information processing system in one aspect of the present disclosure is an information processing system including a plurality of financial institution servers and a secure computing system, and each of the plurality of financial institution servers includes a model storage unit that stores a model that is generated based on information regarding assets of a customer and performs analysis regarding a financial transaction of the customer, a concealing unit that conceals parameters of the model, model input/output means that transmits the model to a secure computing system in a concealed format, and a restoration unit that restores the concealed parameters, and the secure computing system includes parameter acceptance means that accepts, for a plurality of models generated in a plurality of financial institutions and used to analyze a financial transaction based on information regarding assets of the customer, inputs of concealed parameters of the plurality of models, secure computing means that integrates the plurality of concealed parameters by secure computing, and output means that outputs, in a concealed format, the parameters integrated by the secure computing means.

A secure computing method in one aspect of the present disclosure includes accepting, for a plurality of models generated in a plurality of financial institutions and used to analyze a financial transaction based on information regarding assets of a customer, inputs of concealed parameters of the plurality of models, integrating the plurality of concealed parameters by secure computing, and outputting, in a concealed format, the integrated parameters.

A recording medium in one aspect of the present disclosure stores a program for causing a computer to execute accepting, for a plurality of models generated in a plurality of financial institutions and used to analyze a financial transaction based on information regarding assets of a customer, inputs of concealed parameters of the plurality of models, integrating the plurality of concealed parameters by secure computing, and outputting, in a concealed format, the integrated parameters.

### Advantageous Effects of Invention

An example of effects of the present disclosure is that a more accurate financial analysis model can be provided while concealing parameters of each model.

### BRIEF DESCRIPTION OF DRAWINGS

FIG. 1 is a block diagram illustrating a configuration of an information processing system in a first example embodiment.

FIG. 2 is a diagram illustrating a hardware configuration in which a secure computing system in the first example embodiment is achieved by a computer device and its peripheral device.

FIG. 3 is a flowchart illustrating an operation of secure computing in the first example embodiment.

FIG. 4 is a block diagram illustrating a configuration of an information processing system in a second example embodiment.

FIG. 5 is a flowchart illustrating an operation of information processing in the second example embodiment.

### EXAMPLE EMBODIMENT

Next, example embodiments will be described in detail with reference to the drawings.

### First Example Embodiment

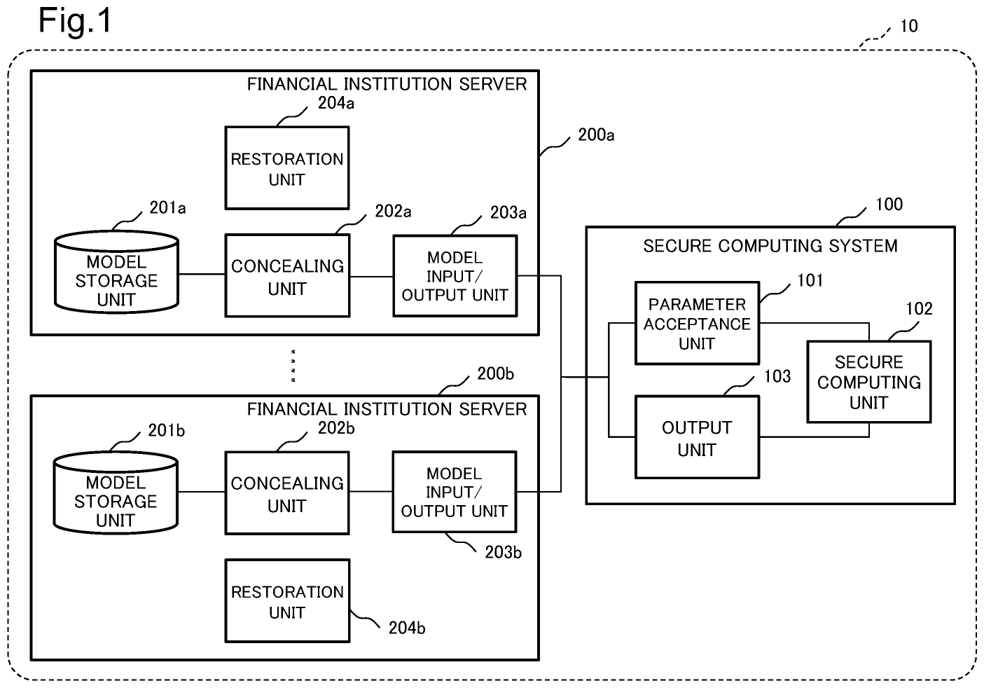

FIG. 1 is a block diagram illustrating a configuration of an information processing system 10 in a first example embodiment. The information processing system 10 in the first example embodiment is a system for integrating, by secure computing, a plurality of parameters of models for analysis using customer information or financial transaction information owned by financial institutions. Referring to FIG. 1, the information processing system 10 includes a secure computing system 100 and a plurality of financial institution servers 200 (200a, 200b). The secure computing system 100 is implemented by a service provider that provides a financial analysis service tool or the like to each financial institution. The service provider integrates parameters of models trained in the financial institution servers 200, and provides the financial analysis service or the like by using an update model to which the integrated parameters are applied. The secure computing system 100 includes a parameter acceptance unit 101, a secure computing unit 102, and an output unit 103. Each of the financial institution servers 200 includes a model storage unit 201 (201a, 201b) that stores a trained model for analyzing customer information or financial transaction information, a concealing unit 202 (202a, 202b) that conceals parameters of the model, a model input/output unit 203 (203a, 203b) that inputs and outputs the parameters to and from the secure computing system 100, and a restoration unit 204 (204a, 204b) that restores the concealed parameters. In the present example embodiment, the number of the plurality of financial institution servers 200 is two, but the number of financial institution servers 200 is not limited to this. The plurality of financial institution servers 200 is provided as many as the number of financial institutions that perform federated learning. Hereinafter, the secure computing system 100 as an essential configuration of the present example embodiment will be described in detail.

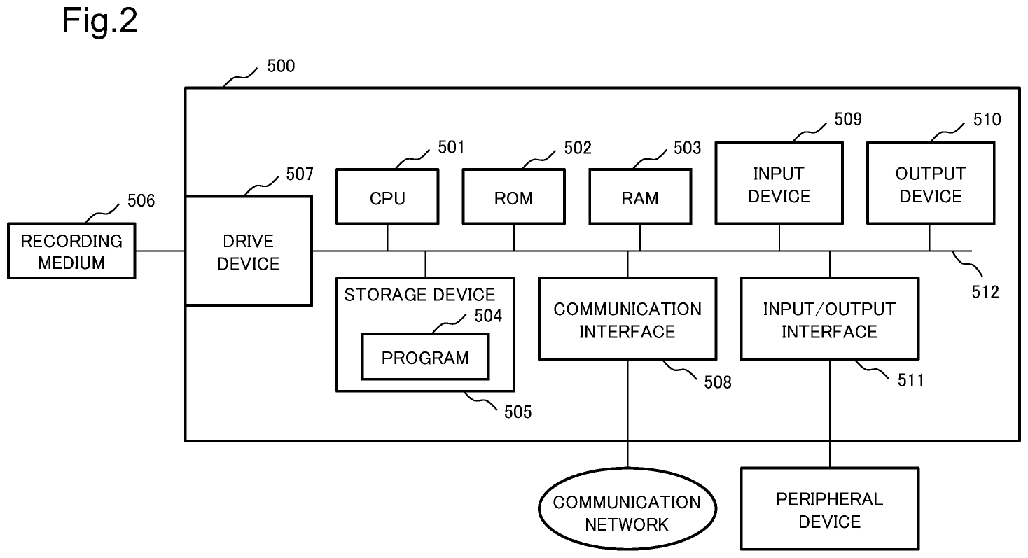

FIG. 2 is a diagram illustrating an example of a hardware configuration in which the secure computing system 100 in the first example embodiment of the present disclosure is achieved by a computer device 500 including a processor. As illustrated in FIG. 2, the secure computing system 100 includes a memory such as a central processing unit (CPU) 501, a read only memory (ROM) 502, and a random access memory (RAM) 503, a storage device 505 such as a hard disk that stores a program 504, a communication interface (I/F) 508 for network connection, and an input/output interface 511 that inputs and outputs data. In the first example embodiment, parameter information received from each of the financial institution servers 200 is input to the secure computing system 100 via the communication I/F 508.

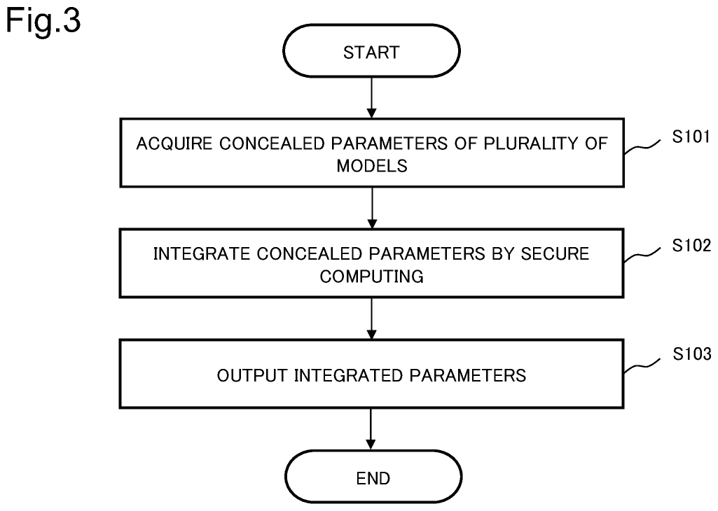

The CPU 501 operates an operating system and controls the entire secure computing system 100 according to the first example embodiment of the present invention. The CPU 501 also reads a program and data from, for example, a recording medium 506 mounted on a drive device 507 or the like to a memory. The CPU 501 also functions as the parameter acceptance unit 101, the secure computing unit 102, the output unit 103, and a part of these in the first example embodiment, and executes processing or a command in a flowchart illustrated in FIG. 3 to be described later based on a program.

The recording medium 506 is, for example, an optical disk, a flexible disk, a magneto-optical disk, an external hard disk, a semiconductor memory, or the like. The recording medium as a part of the storage device is a non-volatile storage device, and records a program. The program may be downloaded from an external computer (not illustrated) connected to a communication network.

An input device 509 is achieved by, for example, a mouse, a keyboard, a built-in key button, or the like, and is used for an input operation. The input device 509 is not limited to a mouse, a keyboard, or a built-in key button, and may be, for example, a touch panel. An output device 510 is achieved by, for example, a display, and is used to confirm an output.

As described above, the first example embodiment illustrated in FIG. 1 is achieved by the computer hardware illustrated in FIG. 2. However, means to achieve each unit included in the secure computing system 100 of FIG. 1 is not limited to the configuration described above. The secure computing system 100 may also be achieved by one physically coupled device, or may also be achieved by a plurality of devices by connecting equal to or more than two physically separated devices in a wired or wireless manner. For example, the input device 509 and the output device 510 may be connected to the computer device 500 via a network. The secure computing system 100 in the first example embodiment illustrated in FIG. 1 can also be configured by cloud computing or the like.

In FIG. 1, the parameter acceptance unit 101 is means that accepts, for a plurality of models generated in a plurality of financial institutions and used for financial analysis based on information regarding assets of customers, inputs of concealed parameters of the plurality of models. The financial analysis is, for example, analysis used by financial institutions to advise customers on financial transactions. The financial institutions include credit card companies and settlement business operators that handle cashless settlement, in addition to business operators that handle financial products, such as banks (including city banks, Japan Post Bank, regional banks, Shinkin banks, and credit associations), securities companies, or insurance companies. As the financial institutions in the first example embodiment, article rental agents that perform a leasing business or a rental business of automobiles and home electric appliances are also included. Examples of the financial products include a deposit, a bond, an investment trust, a foreign currency, a stock, a futures transaction, FX, a virtual currency, or the like.

For example, with an operation for integrating the parameters by the service provider as a trigger, the parameter acceptance unit 101 receives and accepts, in a concealed format, the parameters of the trained model in each of the plurality of financial institution servers 200 via the communication I/F 508 through a network. The model is a model determined in advance by machine learning in order to output a specific analysis result by using, for example, customer information or past financial transaction data in each financial institution. For example, the model is such that, when information regarding assets of a customer is input, a financial product or a financial transaction recommended to the customer, or credit information (credit line) of the customer is output. The model subjected to machine learning includes, but is not limited to, a decision tree model, a linear regression model, a logistic regression model, a neural networks model, and the like.

The secure computing unit 102 is means that integrates, by secure computing, a plurality of concealed parameters accepted by the parameter acceptance unit 101. In the present example embodiment, integrating a plurality of concealed parameters by secure computing means that the secure computing system 100 performs machine learning in a distributed state to each of the financial institution servers 200 (federated learning), and integrates the parameters of the models trained in the financial institution servers 200 by using secure computing. In the present example embodiment, integration of the parameters of the models subjected to machine learning by the financial institution servers 200 by the secure computing system 100 is also included.

The secure computing unit 102 integrates the concealed parameters in accordance with a predetermined combination rule. As a method of integrating the parameters, a known method can be used, and for example, at the time of integration, weights of the parameters related to each model can be changed according to a feature of each model.

As a secure computing method, special encryption related to specific processing such as homomorphic encryption, a trusted execution environment in which processing is performed in a state of being isolated on hardware, multi-party computing in which computing processing (secret sharing computing) is performed while secret sharing is performed by a plurality of servers, or the like can be used. A specific method of secure computing of the multi-party computing includes the following examples. For example, concealed data a is distributed by secret sharing to distributed values x, y, . . . , and x, y, . . . are transmitted to servers with different administrators. Next, computing is advanced while performing communication with each other in a state where the concealed data a is subjected to secret sharing, and finally, distributed values u, v, . . . of outputs, which are computation results of the servers, are collected and restoration processing is performed, whereby F(a) as a computation result is obtained. This computation result is parameters obtained by integrating the parameters of the models. Therefore, in a case where the multi-party computing is used as the secure computing method, the secure computing unit 102 includes a plurality of servers. According to the multi-party computing, management of an encryption key and an isolated environment are unnecessary, and computing processing is faster. The secure computing unit 102 outputs the parameters of the models thus obtained to the output unit 103 in a concealed format.

The output unit 103 is means that transmits parameters integrated by the secure computing unit 102 to the financial institution servers 200 in a concealed format. The output unit 103 transmits the integrated parameters in a format that allows the financial institution servers 20 side to update the parameters of the models. When transmitting to the financial institution servers 200, the output unit 103 can transmit not the updated parameters but a difference (only an improvement point) of the updated parameters.

An operation of the secure computing system 100 configured as described above will be described with reference to the flowchart of FIG. 3.

FIG. 3 is a flowchart illustrating an outline of the operation of the secure computing system 100 in the second example embodiment. Processing according to this flowchart may be executed based on program control by the processor described above.

As illustrated in FIG. 3, first, the parameter acceptance unit 101 accepts inputs of a plurality of concealed parameters for each of models trained in a plurality of financial institutions (step S101). Next, the secure computing unit 102 integrates the plurality of concealed parameters by secure computing (step S102). Finally, the output unit 103 outputs parameters of the models computed by the secure computing unit 102 in a concealed format (step S103). Thus, the secure computing system 100 ends the operation of secure computing.

In the secure computing system 100, the secure computing unit 102 integrates a plurality of concealed parameters by secure computing. As a result, a more accurate model can be provided while concealing parameters of each model.

### Second Example Embodiment

Next, a second example embodiment of the present disclosure will be described in detail with reference to the drawings. Hereinafter, description of contents overlapping with the above description will be omitted to the extent that the description of the present example embodiment is not unclear. An information processing system 11 in the second example embodiment is used to provide models updated using federated learning using secure computing. These update models are incorporated into, for example, an analysis tool for providing advice regarding financial transactions to customers and setting credit lines of customers (loan examination). The advice regarding financial transactions also includes advice on financial management strategies and financial product transactions for corporations, and examples of the advice include M&A support or recommendation of financial products/services. The financial transaction in the present example embodiment refers to a normal financial transaction, and is a concept excluding an illegal transaction and illegality detection that are problematic in financial transactions. Similarly to the computer device illustrated in FIG. 2, functions of each component in each example embodiment of the present disclosure can be achieved not only by hardware but also by a computer device or firmware based on program control. These models are models generated based on customer information or financial transaction information regarding assets of customers, and are stored in model storage units 211 (211a, 211b) of financial institution servers 210 (210a, 210b).

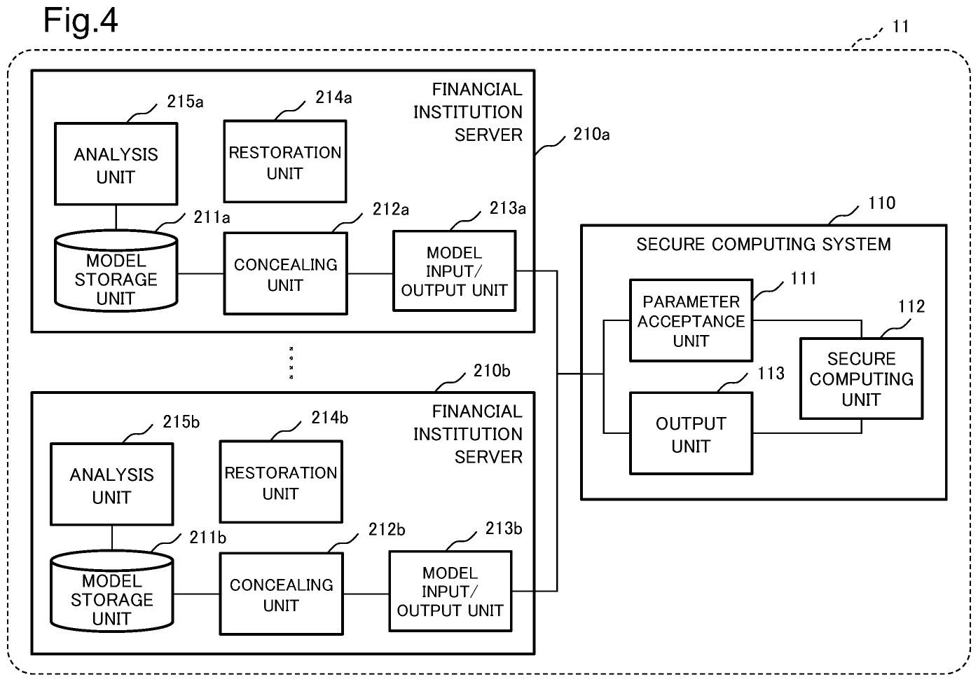

FIG. 4 is a block diagram illustrating a configuration of the information processing system 11 including a secure computing system 110 according to the second example embodiment of the present disclosure. With reference to FIG. 4, the secure computing system 110 and the financial institution servers 210 (210a, 210b) according to the second example embodiment will be described focusing on portions different from those of the information processing system 10 according to the first example embodiment. The secure computing system 110 according to the second example embodiment includes a parameter acceptance unit 111, a secure computing unit 112, and an output unit 113. The plurality of financial institution servers 210 (210a, 210b) includes the model storage units 211 (211a, 211b), concealing units 212 (212a, 212b), model input/output units 213 (213a, 213b), restoration units 214 (214a, 214b), and analysis units 215 (215a, 215b). The secure computing system 110 integrates, by using secure computing, a plurality of parameters of trained models received from the plurality of financial institution servers 210a and 210b.

Here, details of each model used in a financial analysis tool for corporations will be described. Models of M&A support includes a model used by an acquiring side and a model used by a seller (an acquired side) side. The acquiring side model is, for example, a model obtained by learning an industry type, sales, a region, or the like as teacher data based on past successful examples. This model accepts an input of a name of a company that is desired to acquire, and outputs acquisition availability and an acquisition amount. The seller side model is, for example, a model obtained by learning an industry type, sales, a region, or the like as teacher data based on past successful examples. This model accepts an input of a name of a desired acquisition destination company, and outputs a possibility that the company desires acquisition and a desired expected acquisition amount. For these models, by integrating parameters of trained models in a plurality of financial institutions, matching between a buyer and a seller can be made accurate, and a loan opportunity can be increased.

A model of loan examination outputs, for example, a loan amount (increased amount, refinancing, extension of period) with a repayment status of a company that is an existing customer as an input value. By integrating parameters of models trained in a plurality of financial institutions, it is possible to facilitate determination of loan and examination operations and improve efficiency of the operations. A model of recommendation of products/services accepts inputs of customer information and transaction details of a past certain period, and outputs a financial product or financial products recommended to a customer. By integrating parameters of models trained in a plurality of financial institutions, it is possible to output a more accurate analysis result and to increase a loan opportunity.

### <Secure Computing System>

The secure computing unit 112 receives parameters of trained models of financial institutions from the financial institution servers 210 through a communication I/F 508. Next, the secure computing unit 112 integrates, by secure computing, the received parameters of the concealed models in accordance with a predetermined combination rule, and outputs the integrated parameters of the concealed models to the output unit 113 in a concealed format. The output unit 113 transmits the integrated parameters to the financial institution servers 210 through the model input/output units 213. After the parameters are transmitted to the financial institution servers 210, in a case where the financial institution servers 210 side performs training of the models again and the parameters are updated, the secure computing system 110 may receive the updated parameters again. Operations in the parameter acceptance unit 111, the secure computing unit 112, and the output unit 113 are similar to the operations in the parameter acceptance unit 101, the secure computing unit 102, and the output unit 103 in the first example embodiment, and thus, description of the operations is omitted here.

### <Financial Institution Server>

The financial institution servers 210 update models stored in the model storage units 211 to models to which parameters received from the secure computing system 110 are applied. Specifically, the model input/output units 213 receive the parameters in a concealed format, and output the received parameters to the restoration units 214. Next, the restoration units 214 restore the parameters, and replace the parameters with parameters of the models stored in the model storage units 211. Next, the analysis units 215 perform analysis by using the updated models. The updated models are incorporated into financial analysis tools for corporations used in financial institutions. With an operation on the financial analysis tool by a user as a trigger, the analysis units 215 perform analysis related to M&A by using the updated update models, and output analysis results in a state where the analysis results can be viewed on a display device or the like. In a tool using an acquiring side model, for example, the analysis units 215 accept an input of a name of a company desired to acquire, and output acquisition availability and an acquisition amount. In a tool using a seller side model, for example, the analysis units 215 accept an input of a name of a desired acquisition destination company, and output a possibility that the desired acquisition destination desires acquisition and a desired expected acquisition amount. In order to improve accuracy of analysis results by the analysis units 215, the financial institution servers 210 may perform training again based on additionally obtained customer data and financial transaction information, and may transmit further updated parameters to the secure computing system 110. Accuracy of a model can be further improved by repeating updating of the parameters by training in each of the financial institution servers 210 and integration of the parameters in the secure computing system 110 until, for example, a predetermined condition is satisfied. The predetermined condition is stored in, for example, the storage device 505.

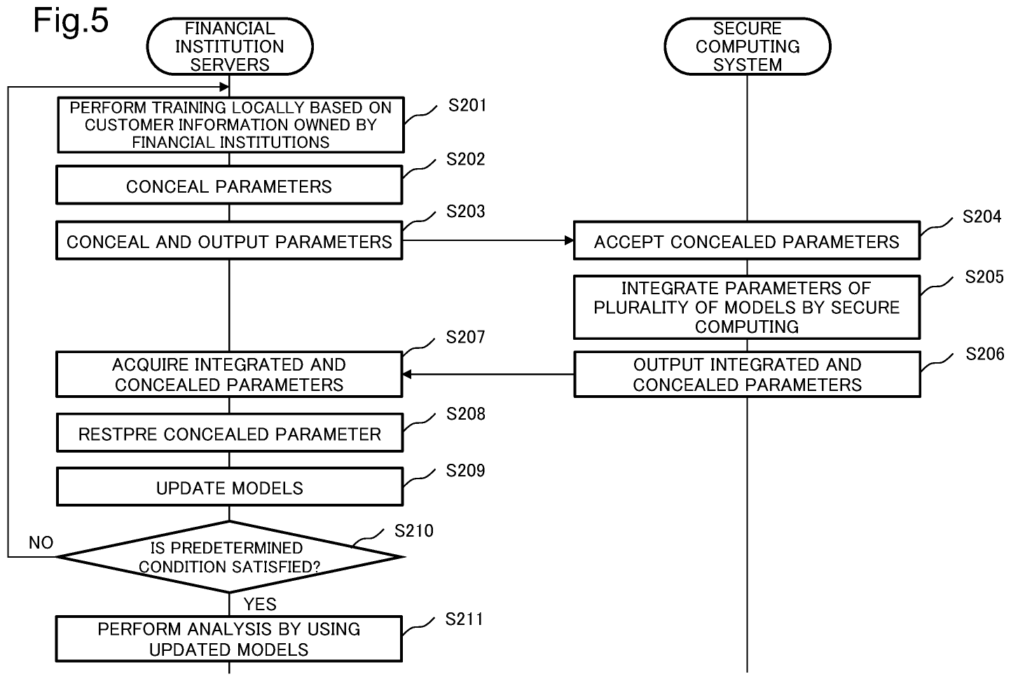

An operation of the information processing system 11 configured as described above will be described with reference to a flowchart of FIG. 5.

FIG. 5 is a flowchart illustrating an outline of the operation of the information processing system 11 in the first example embodiment. Processing according to this flowchart may be executed based on program control by the processor described above.

As illustrated in FIG. 5, first, the financial institution servers 210 perform training locally based on customer information owned by financial institutions (step S201). Next, the concealing units 212 conceal parameters of models trained in the financial institution servers 210 (step S202). Next, the model input/output units 213 output the parameters to the secure computing system 110 in a concealed format (step S203). Next, the parameter acceptance unit 111 of the secure computing system 110 accepts the concealed parameters (step S204). Next, the secure computing unit 112 integrates the plurality of concealed parameters by secure computing (step S205). Next, the output unit 113 outputs the parameters of the models integrated by the secure computing unit 112 to each of the financial institution servers 210 in a concealed format (step S206). Next, the financial institution servers 210 acquire the integrated parameters in a concealed format through the model input/output units 213 (step S207). Next, the restoration units 214 restore the concealed parameters (step S208). Next, the financial institution servers 210 update models stored in the model storage units 211 to models to which the restored parameters are applied (step S209). Next, the financial institution servers 210 determine whether a predetermined condition is satisfied (step S210). In a case where the predetermined condition is satisfied (step S210; YES), the analysis units 215 perform analysis by using the updated models, and end the flow (step S211). In a case where the predetermined condition is not satisfied, the financial institution servers 210 return to step S201 (step S210; NO) and implement the flow again. Thus, the information processing system 11 ends the operation of secure computing.

In the second example embodiment of the present disclosure, by integrating parameters of a plurality of models for supporting corporations, it is possible to output a more accurate analysis result.

### Modification of Second Example Embodiment

The information processing system 11 in the second example embodiment can also be used in a system for integrating parameters of trained models for supporting individuals in financial institutions. Examples of the models of which parameters are to be integrated include models of loan examination, purchase prediction, cancellation prediction, and the like. The model of loan examination outputs an amount to be lent with a customer attribute and a repayment status as input values. Purchase prediction outputs determination as to whether to recommend a financial product of a financial institution or determination as to which financial product to recommend, with statuses of transactions for a past certain period as input values. Cancellation prediction outputs a result obtained by scoring, for each customer of a financial institution, a possibility of advanced repayment of a loan and a possibility of time deposit cancellation/account cancellation, with statuses of transactions of each financial institution for a past certain period as input values.

The information processing system 11 can also use a model related to personnel affairs (evaluation/appropriateness/transfer) of a financial institution. The model of personnel affairs determines a separation probability, a promotion probability, necessity of transfer, a transfer destination, and the like of an employee from personnel affairs information of the employee in a past certain period. By integrating parameters of this model, a time for determination can be reduced, and efficiency of operations can be improved.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, although the plurality of operations is described in order in the formats of the flowcharts, the order of description does not limit the order of execution of the plurality of operations. Therefore, when each example embodiment is implemented, the order of the plurality of operations can be changed within a range that does not interfere in content.

In the present example embodiment, the plurality of financial institutions is not limited to financial institutions of the same industry type, and may include a bank and a financial institution other than the bank, such as a bank and a securities company or an insurance company. Even in a case where the plurality of financial institutions includes banks, the financial institutions may include banks having different scales such as a city bank and a regional bank.

A part or all of the example embodiments described above may also be described as the following supplementary notes, but are not limited to the following.

### (Supplementary Note 1)

A secure computing system including:
parameter acceptance means configured to accept, for a plurality of models generated in a plurality of financial institutions and used to analyze a financial transaction based on information regarding assets of a customer, inputs of concealed parameters of the plurality of models;
secure computing means configured to integrate the plurality of concealed parameters by secure computing; and
output means configured to output, in a concealed format, the parameters integrated by the secure computing means.

### (Supplementary Note 2)

The secure computing system according to Supplementary Note 1, in which the model is a model that accepts an input of desired partner information of M&A and outputs acquisition availability or an expected acquisition amount.

### (Supplementary Note 3)

The secure computing system according to Supplementary Note 1, in which the model is a model that accepts an input of the information regarding the assets of the customer and outputs credit information of the customer.

### (Supplementary Note 4)

The secure computing system according to Supplementary Note 1, in which the model is a model that accepts an input of the information regarding the assets of the customer and outputs a financial product or a financial transaction for recommendation to the customer.

(Supplementary Note 5) The secure computing system according to any one of Supplementary Notes 1 to 4, in which the secure computing is secret sharing computing.

### (Supplementary Note 6)

A financial institution server including analysis means regarding a financial transaction of a customer by using an update model updated by federated learning using secure computing based on customer information or financial transaction information regarding assets of the customer.

### (Supplementary Note 7)

The financial institution server according to Supplementary Note 6, in which the analysis means performs analysis regarding M&A by using the update model updated by the federated learning using the secure computing based on financial transaction information regarding a past M&A case as the financial transaction information.

### (Supplementary Note 8)

The financial institution server according to Supplementary Note 6, in which the analysis regarding the financial transaction of the customer by the analysis means is analysis regarding credit information of the customer.

### (Supplementary Note 9)

The financial institution server according to Supplementary Note 6, in which the analysis regarding the financial transaction of the customer by the analysis means is analysis of a financial product for recommendation to the customer.

### (Supplementary Note 10)

An information processing system including a plurality of financial institution servers and a secure computing system,
each of the plurality of financial institution servers including:
a model storage unit that stores a model that is generated based on information regarding assets of a customer and performs analysis regarding a financial transaction of the customer;
a concealing unit that conceals parameters of the model stored in the model storage unit;
model input/output means configured to transmit the model concealed by the concealing unit to a secure computing system in a concealed format; and
a restoration unit that restores the concealed parameters,
the secure computing system including:
parameter acceptance means configured to accept, for a plurality of models generated in a plurality of financial institutions and used to analyze a financial transaction based on information regarding assets of the customer, inputs of concealed parameters of the plurality of models;
secure computing means configured to integrate the accepted plurality of concealed parameters by secure computing; and
output means configured to output, in a concealed format, the parameters integrated by the secure computing means.

### (Supplementary Note 11)

A secure computing method including:
accepting, for a plurality of models generated in a plurality of financial institutions and used to analyze a financial transaction based on information regarding assets of a customer, inputs of concealed parameters of the plurality of models;
integrating the plurality of concealed parameters by secure computing; and
outputting, in a concealed format, the integrated parameters.

### (Supplementary Note 12)

A recording medium storing a program for causing a computer to execute:
accepting, for a plurality of models generated in a plurality of financial institutions and used to analyze a financial transaction based on information regarding assets of a customer, inputs of concealed parameters of the plurality of models;
integrating the plurality of concealed parameters by secure computing; and
outputting, in a concealed format, the integrated parameters.

### REFERENCE SIGNS LIST

10, 11 information processing system
100, 110 secure computing system
101, 111 parameter acceptance unit
102, 112 secure computing unit
103, 113 output unit
200, 210 financial institution server
201, 211 model storage unit
202, 212 concealing unit
203, 213 model input/output unit
204, 214 restoration unit
215 analysis unit

What is claimed is:

1. A secure computing system comprising:
a memory storing instructions; and
at least one processor configured to execute the instructions to:
accept, for a plurality of models generated in a plurality of financial institutions and used to analyze a financial transaction based on information regarding assets of a customer, inputs of concealed parameters of the plurality of models;
integrate the plurality of concealed parameters by secure computing; and
output, in a concealed format, the parameters integrated.

2. The secure computing system according to claim 1, wherein the model is a model that accepts an input of desired partner information of M&A and outputs acquisition availability or an expected acquisition amount.

3. The secure computing system according to claim 1, wherein the model is a model that accepts an input of the information regarding the assets of the customer and outputs credit information of the customer.

4. The secure computing system according to claim 1, wherein the secure computing is secret sharing computing.

5. A financial institution server comprising:
a memory storing instructions; and
at least one processor configured to execute the instructions to:
perform analysis regarding a financial transaction of a customer by using an update model updated by federated learning using secure computing based on customer information or financial transaction information regarding assets of the customer.

6. The financial institution server according to claim 5, wherein the at least one processor is further configured to execute the instructions to:
perform analysis regarding M&A by using the update model updated by the federated learning using the secure computing based on financial transaction information regarding a past M&A case as the financial transaction information.

7. The financial institution server according to claim 5, wherein the analysis regarding the financial transaction of the customer is analysis regarding credit information of the customer.

8. An information processing system including a plurality of financial institution servers and a secure computing system,
each of the plurality of financial institution servers comprising:
a memory storing instructions; and
at least one processor configured to execute the instructions to:
store a model that is generated based on information regarding assets of a customer and performs analysis regarding a financial transaction of the customer;
conceal parameters of the model stored;
transmit the model concealed to a secure computing system in a concealed format; and
restore the concealed parameters,
the secure computing system comprising:
a memory storing instructions; and
at least one processor configured to execute the instructions to:
accept, for a plurality of models generated in a plurality of financial institutions and used to analyze a financial transaction based on information regarding assets of the customer, inputs of concealed parameters of the plurality of models;
integrate the concealed parameters by secure computing; and
output, in a concealed format, the parameters integrated.

9. A secure computing method comprising:
accepting, for a plurality of models generated in a plurality of financial institutions and used to analyze a financial transaction based on information regarding assets of a customer, inputs of concealed parameters of the plurality of models;
integrating the plurality of concealed parameters by secure computing; and
outputting, in a concealed format, the integrated parameters.

10. (canceled)
